(19) United States
(12) Patent Application Publication
(10) Pub. No.: US 2014/0203566 A1
(43) Pub. Date: Jul. 24, 2014

(54) WIND TURBINE

(71) Applicant: Hong Yuan, Chongqing (CN)

(72) Inventor: Hong Yuan, Chongqing (CN)

(21) Appl. No.: 14/125,948

(22) PCT Filed: May 16, 2012
(86) PCT No.: PCT/CN2012/000675

§ 371 Date: Dec. 13, 2013

(30) Foreign Application Priority Data
May 18, 2011 (CN) 201110148490.6

(51) Int. Cl. F03D 9/00

(52) U.S. Cl. CPC F03D 9/002
USPC 290/55

(57) ABSTRACT

A wind turbine is provided to overcome the low conversion rates of existing thermal wind turbines, which are unable to meet the growing demand for power. A wind turbine tower (7) is provided with a shaft (3) that extends vertically from the bottom or the middle of the tower to the top of the tower. The top end of the shaft is connected to the rotation shaft of a generator (2). A flywheel (4) is provided at the bottom of the shaft (3). Air inlets (8) are provided about the tower wall at the bottom of the tower and are oriented upward. A screw flight (31) is provided about the shaft, spiraling upward from the bottom to the top thereof. The wind turbine reduces loss of wind power, makes full use of wind energy, and achieves wind-to-power conversion rates of at least 85%.

### FIELD OF THE INVENTION

The invention relates to new energy technology and, in particular relates to a wind power generation apparatus.

### BACKGROUND ART

Wind is a clean and renewable natural resource with immense potential, and is attracting ever more attention from countries in the world. The exploitation means are numerous, such as is provided by the present inventor in the application 201020184100.1, “A heated wind power generation apparatus”, which employs natural solar energy as a heat source. Air at the bottom of the tower is heated, and according to the principle of air flow and under the influence of air pressure, the heated air flows up. Also, the inner diameter of the tower of the heated wind power generation apparatus at the bottom is larger than that at the top, creating a suction force to pull up the heated air at a high speed. The vanes of the generator are hanged vertically at the exit of the top of the tower, that is, the vanes revolve about the center of a shaft circularly in an upward direction, transforming wind kinetic energy to mechanical energy and then mechanical energy to electrical energy. The transforming rate reaches 60%, but is far from meeting the increasing needs for power generation.

### SUMMARY OF THE INVENTION

The present invention is directed at the fore-going deficiency, by comprehensively utilizing nature-provided energy, improving mechanical structures, making full use of limited resources, so as to increase the energy transforming rate of the wind power generation apparatus.

The invention will be further expounded via its structure in the following:
a wind power generation apparatus, with a wind power generation tower in the form of a chimney having an inner diameter at the bottom of the tower larger than that at the top of the tower, a generator arranged at the opening of the top of the tower, and a wind permeable canopy arranged at the top of the tower, a shaft vertically passing through from the bottom or from within the tower to the top of the tower; the top end of the shaft is connected to a rotor of the generator; a wheel is arranged at the bottom of the shaft; a plurality of air inlets are arranged upwards around the circumference of the wall of the tower at the bottom of the tower; a plurality of vanes are provided in an upward spiral way from the bottom of the shaft to the top of the shaft.

For better effects, the intervals provided between the vanes from bottom to top are in descending order.

The diameters of the vanes from bottom to top are in descending order, and the edges of the vanes are spaced apart from the wall of the tower by distances of 0.001˜1 mm.

A semi-circular solar concentrating panel is arranged at the bottom of the tower, the reflection focus of the solar concentrating panel is aimed at an electric heating radiator with a temperature control switch, the electric heating radiator is arranged therebetween under the wheel and above the wind inlets.

The inner wall of the tower for wind power generation tower is smooth, the inner diameter decreases smoothly and evenly from the bottom of the tower to the top of the tower; a threading in ascending ladder form coincides with a spiralling path of the vanes (31) arranged at the inner wall.

The shaft passing through and along the tower may run from the bottom of the tower to the top of the tower, with one generator arranged at the top of the tower; the shaft may also run from any position within the tower to the top of the tower, with one generator arranged at the top of the tower; multiple shafts may also be installed in sections in the tower, with one generator installed at each top of the shaft, each generator transmits electricity to a power distribution room via transmission lines, with a portion of the electricity in the distribution room coupled to the electric heating radiator.

The tower for the wind power generator may also be assembled by joining one with another. That is, the bottom of the second tower joins a part of the top of the first tower, the space between the bottom of the second tower and the top of the first tower is fully closed, a second electric heating radiator with temperature control switch arranged on the top of the generator lying on the top of the first tower, the portion of the second tower from the bottom to the second electric heating radiator is transparent, a second semi-circular solar concentrating panel arranged on the outer periphery of the transparent portion of the second tower, the reflection focus of the second concentrating panel is aimed at the second electric heating radiator with temperature control switch at the center of the bottom of the second tower, a second generator is arranged at the opening on the top of the second tower; the same goes for multiple towers joining one another, with a wind permeable canopy arranged on the top of the uppermost tower.

A lightning prevention device is arranged on the wind permeable canopy on the top of the uppermost tower.

The spiralling shaft runs from the bottom of the tower for wind power generator to the top of the tower, a wheel arranged at the bottom of the spiralling shaft, which steadies the speed of the shaft, to shield from outside influences, to accumulate potential energy, and to provide a guarantee for a balanced operation of the apparatus; a plurality of vanes spiralling upwards are arranged to run from the bottom to the top of the shaft, the vanes rotate under the wind of the air flow flowing upwards, the upwards spiralling vanes function to increase pressure and speed, so as to provide speed and momentum for the transformation of mechanical energy to electrical energy; air flow in its upward flow exert fully on the vanes running along the tower, which increases the force bearing area and increases the exerting force; the top end of the shaft is connected with the rotor of the generator, by the principle of shaft-to-shaft connection for mechanical rotation, this decreases energy consumption compared with the open mode in the case of wind as power where the vanes revolve circularly around their axis, thus wind power is fully made use of, the energy transformation rate is increased to over 85%; at the bottom of the tower and around the wall of the tower there are arranged multiple wind inlets, the inclined and tangential wind inlets make wind power concentrated, and make the wind flow move in the same direction as the vanes, and exert in an appropriate position on the also inclined and tangential vanes, thus makes good use of the available wind power.

The vanes fully exploit mechanics in their design. The distance between the neighboring varies decreases as they move upwards, and so does the diameter of the vanes; the tip of the vanes is spaced apart from the wall of the tower by distances of 0.001˜1 mm, the small distances enable wind power to do its full work, and to decrease wind power consumption.

A semi-circular solar concentrating panel is arranged at the bottom of the tower, the reflection focus thereof is aimed at the electric heating radiator with temperature control switch arranged at the center of the tower, the electric heating radiator is arranged under the wheel and above the wind inlets. Air flow at the bottom of the tower is heated and becomes the source of wind power, and according to the dynamics of air flow, the heated air flow flows upwards under pressure. Further, bigger size of the diameter at the bottom over that at the top of the tower creates a suction force, enabling the heated air flow to quickly pull upwards.

The inner wall of the wind power generation tower is smooth, the inner diameter decreases smoothly and evenly from the bottom of the tower to the top of the tower, decreasing drag on the air flow; a spiralling threading is arranged at the inner wall which corresponds with the spiralling path of the vanes, the threading spirals upwards with decreasing distancing in synchronization with the vanes, which increases pressure on the air flow and prevents its backward flow, thus increasing strength and speed of the upward air flow.

### DESCRIPTION OF THE DRAWING

The invention is further expounded in combination with the Drawing and the embodiments in the following:

FIG. 1 is a structural schematic diagram of the present invention.

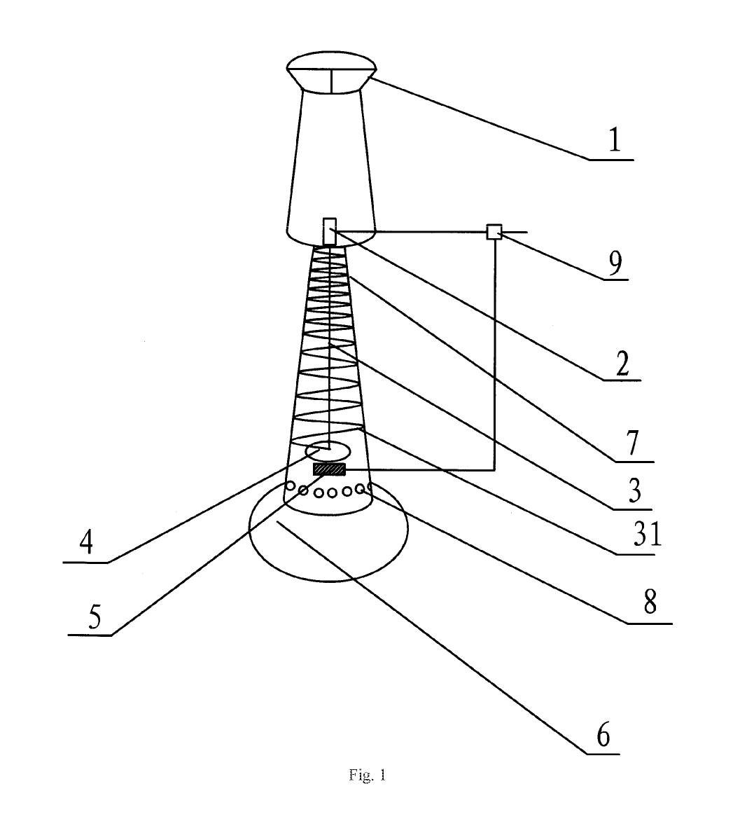

### IMPLEMENTATION OF THE EMBODIMENTS

### Embodiment 1

A wind power generation apparatus, with a wind power generation tower 7 in chimney form, with the inner diameter at the bottom larger than that at the top of the tower, a generator 2 provided at the opening of the top of the tower, a wind permeable canopy 1 provided at the top of the tower, a shaft runs vertically from the bottom or the middle of the tower to the top of the tower along the wind power generation tower 7, the top end of the shaft is connected with a rotor of the generator, a wheel is arranged at the bottom of the shaft, wind inlets 8 are arranged at the bottom of the tower along the circumference of the wall of the tower, vanes 31 are arranged in an upward spiral way from the bottom of the shaft to the top of the shaft. Distance between neighboring vanes decreases as the vanes move upwards. The diameter of the vanes decreases as the vanes move upwards, the tips of the vanes are spaced apart by 0.001 mm from the wall of the tower.

A solar concentrating panel 6 which is semi-circular is arranged at the bottom of the tower, the reflection focus of the solar concentrating panel 6 is aimed at a electric heating radiator 5 with temperature control switch, the electric heating radiator 5 is placed beneath a wheel 4 and above a plurality of wind inlets 8. The wind power generation tower 7 has a smooth inner wall, the inner diameter thereof tapers smoothly and evenly from the bottom of the tower to the top of the tower, an upward spiralling threading in ladder form coinciding with the spiralling path of the vanes 31 is arranged on the inner wall.

### Embodiment 2

A shaft 3 running along the tower may run from the bottom of the tower to the top of the tower, or from any position within the tower to the top of the tower, a generator 2 is arranged at the top of the tower; the shaft 3 may also be installed as multiple shafts, with a generator 2 arranged at the top end of each shaft, each generator 2 transmits electrical power via a transmission line to a power distribution room 9, with a portion of the electrical power from the power distribution room 9 coupled with a electric heating radiator 5. A wind permeable canopy 1 is arranged on the top of the tower, the shaft 3 runs from the bottom or the middle of the tower to the top of the tower, the top end of the shaft is connected with the rotor of the generator, at the bottom of the shaft is arranged a wheel 4, wind inlets 8 are arranged at the bottom of the tower along the circumference of the tower, a plurality of vanes spiralling upwards are arranged from the bottom of the shaft to the top of the shaft. Distance between neighboring vanes decreases as the vanes move upwards. The diameter of the vanes decreases as the vanes move upwards, the tips of the vanes are spaced apart by 1 mm from the wall of the tower.

### Embodiment 3

The wind power generation tower 7 may also be assembled by joining one with another, that is, the bottom of the second tower joins a part of the top of the first tower, the space between the bottom of the second tower and the top of the first tower is fully closed, a second electric heating radiator 5 with temperature control switch arranged on the top of the generator 2 lying on the top of the first tower, the portion of the second tower from the bottom thereof to the second electric heating radiator 5 is transparent, a second semi-circular solar concentrating panel 6 is arranged on the outer periphery of the transparent portion of the second tower, the reflection focus of the second concentrating panel 6 is aimed at the second electric heating radiator 5 with temperature control switch, a second generator 2 is arranged at the opening on the top of the second tower; The diameter of the vanes 31 decreases as the vanes move upwards, the tips of the vanes are spaced apart by 0.05 mm from the wall of the tower.

The same goes for multiple towers joining one another, with a wind permeable canopy 1 arranged on the top of the uppermost tower.

1. A wind power generation apparatus, with a wind power generation tower in chimney form having an inner diameter at a bottom of the tower larger than an inner diameter at the top of the tower, a generator arranged at the opening of the top of the tower, a wind permeable canopy arranged on the top of the tower, the apparatus comprising:
the tower for wind power generation has a shaft from bottom of the tower or from within the tower to the top of the tower, a top end of the shaft is connected with a rotor of the generator, a wheel arranged at a bottom of the shaft, a plurality of wind inlets are arranged upwards at the bottom of the tower along a circumference of a wall of the tower, a plurality of vanes are arranged in an upward spiral way from the bottom of the shaft to a top of the shaft;
multiple shafts are installed in sections in the tower, with one generator installed at each top of shaft, each generator transmits electrical power via a transmission line to a power distribution room, with a portion of the electrical power from the power distribution room coupled to a electric heating radiator;
the intervals provided between two neighboring vanes from bottom to top are in descending order; a diameter of the vanes decreases as the vanes move upwards, the edges of the vanes spaced apart from the wall of the tower by 0.001˜1 mm.

2-3. (canceled)

4. The wind power generation apparatus of claim 1, further comprising:
a solar concentrating panel in semi-circular form arranged at the bottom of the tower, a reflection focus of the solar concentrating panel is aimed at a electric heating radiator with temperature control switch arranged at a center of the tower, the electric heating radiator is arranged therebetween under the wheel and above the wind inlets.

5. The wind power generation apparatus of claim 1, characterized in that: an inner wall of the tower for wind power generation is smooth, an inner diameter of the wall decreases smoothly and evenly from the bottom of the tower to the top of the tower, a threading in ascending ladder form which coincides with a spiraling path of the vanes arranged along the inner wall of the tower.

6. The wind power generation apparatus of claim 1, further comprising:
the shaft passing through along the tower may run from the bottom of the tower to the top of the tower, the generator is configured at the top of the tower; or from any position within the tower to the top of the tower, the generator is arranged at the top of the tower.

7. The wind power generation apparatus of claim 1, further comprising: the tower for wind power generation is assembled by joining one with another, that is, the bottom of a second tower joins a part of the top of a first tower, the space between the bottom of the second tower and the top of the first tower is fully closed, a second electric heating radiator with temperature control switch arranged on the top of the generator lying on the top of the first tower, the portion of the second tower from the bottom thereof to the second electric heating radiator is transparent, a second semi-circular solar concentrating panel arranged on the outer periphery of the transparent portion of the second tower, the reflection focus of the second concentrating panel is aimed at the second electric heating radiator with temperature control switch, a second generator is arranged at the opening on the top of the second tower;
the same goes for multiple towers joining one another, with a wind permeable canopy arranged on the top of an uppermost tower.

8. The wind power generation apparatus of claim 7, further comprising:
a lightning prevention device is arranged on the wind permeable canopy on the top of the uppermost tower.
